(19) United States
(12) Patent Application Publication
(10) Pub. No.: US 2022/0242629 A1
(43) Pub. Date: Aug. 4, 2022

(54) FOOD CONTAINER COMPRISING A GAS PERMEABLE BARRIER

(71) Applicant: KING'S FLAIR INNOVATIVE MARKETING LIMITED, Hong Kong (CN)

(72) Inventor: Siu Wah WONG, Hong Kong (CN)

(21) Appl. No.: 17/629,646

(22) PCT Filed: Jul. 24, 2020
(86) PCT No.: PCT/IB2020/056986

§ 371 Date: Jan. 24, 2022

Related U.S. Application Data
(60) Provisional application No. 62/877,896, filed on Jul. 24, 2019.

(51) Int. Cl. B65D 51/16

(52) U.S. Cl. CPC B65D 51/1616; B01D 69/02; B65D 51/1627

(57) ABSTRACT

A food container comprises a container body having an open top, and a moisture-tight and gas permeable barrier (102) removably deployed to serve as a barrier to at least a part of the open top of the container in a manner to allow gas inside the container body to pass therethrough while to prevent moisture from being escaped from the container body.

### CROSS-REFERENCE TO RELATED APPLICATION

This application claims benefit of U.S. Provisional Application having Ser. No. 62/877,896 filed on 24 Jul. 2019, which is hereby incorporated by reference herein in its entirety.

### FIELD OF THE INVENTION

The present invention relates generally to the technical field of kitchenware, and particularly to a food container having a barrier which is moisture-tight and gas (e.g. air) permeable and which is adapted to fit onto a food container body or a cover of the food container. The food container of the present invention enables food items to be steamed and heated in an oven (e.g. microwave oven) as it enables gas to pass through the barrier but water is trapped inside the food container.

### BACKGROUND OF THE INVENTION

With increasing varieties and categories of food and beverages, a food container adapted for keeping food fresh, ready-to-eat and ready for cooking have been receiving considerable attention as consumers become more conscious of health, convenience and quality of food.

To maintain the quality of food during transportation and storage, efforts have been focused on modifying or controlling the internal atmospheric environment taking the advantage of permeability of a barrier used with the food container.

Regarding microwave heating or steaming of food in the container, it is desirable to maintain water content in the container with the use of a barrier having breathability requirements while allowing maximum quality and nutrient retention.

There exists a need for a food container that is conveniently fitted with a moisture-tight and gas permeable barrier under all circumstances for keeping food fresh and for cooking, in further consideration of environmental concern to reuse the barrier.

### SUMMARY OF THE INVENTION

An object of the present invention is to provide a food container having a moisture tight and gas permeable barrier adapted for the food container. The barrier, for example, presses fit onto an inner wall surface of the food container, or is placed over an open top of the food container, or forms as a part of the cover of the food container. The food container with this barrier enables the food items to be steamed and heated in a microwave oven as it enables air to pass through the barrier but water inside the container body is trapped and cannot escape. The barrier can cover partially or fully the cross-section of the container for this purpose. The barrier of the invention is reusable, hydrophobic, and is used for keeping food fresh and for cooking.

The object of the invention can be attained by providing a food container comprising:

a container body having an open top and

a moisture-tight and gas permeable barrier removably deployed to serve as a barrier to at least a part of the open top of the container in a manner to allow gas inside the container body to pass therethrough while to prevent moisture from being escaped from the container body.

Preferably, the barrier is adapted to removably fit onto an inner wall surface of the container body or over the open top of the container body to fully cover a cross-section of the container body.

According to one preferred embodiment of the invention, the food container further comprises a retainer for releasably retaining the barrier, the retainer being adapted to removably press fit to the container body.

Advantageously, the retainer comprises:

an upper perimetric ring, and

a lower perimetric ring engageable with the upper perimetric ring,

wherein the barrier is hermetically and releasably mounted between the upper perimetric ring and lower perimetric ring.

In another embodiment of the invention, the food container further comprises a cover for hermetically closing the container body so as to be openable and closable, wherein the cover comprises a through hole with which the barrier is engageable tightly. Preferably, the food container further comprises a retainer for releasably retaining the barrier, the retainer being adapted to removably press fit to the container body, or removably press into or be integral with the through hole of the cover. Advantageously, the retainer comprises an upper perimetric ring, and a lower perimetric ring engageable with the upper perimetric ring. The barrier is hermetically and releasably mounted between the upper perimetric ring and lower perimetric ring. In one specific embodiment, one of the upper perimetric ring and the lower perimetric ring is integral with the through hole of the cover, and the other is removably engageable with said perimetric ring integral with the cover.

According to the food container of the invention, the retainer may be annular, rectangular, or ovoid in shape, depending on the shape of the container body.

In one preferred embodiment of the invention, the barrier is formed as a flat piece of porous plastic configured to be permeable to gas while remaining impermeable to moisture or liquid. The flat piece of porous plastic may be formed as a plastic film or a plastic sheet. Preferably, the porous plastic comprises a microstructure and/or nanostructure formed by eliminating encapsulated micro- or nano-particles present in the plastic.

In the present invention, the moisture-tight and gas permeable barrier may be provided in the form of a membrane comprising one or more hydrophobic nanofiber polymers, e.g. Poly(ε-caprolactone)s (PCL), Poly(lactide/glycolide) (PLGA), Poly(d,l-lactide)s (PLA), Polydimethylsiloxane (PDMS), through which air is permeable but water is impermeable at any conditions, e.g. in the fridge, room temperature, under microwave heating or steaming.

Examples of the barrier may be provided in the form of woven or non-woven cloth. The barrier may also be a porous polymeric material membrane, e.g. a microporous polymeric material membrane.

The objects, characteristics, advantages and technical effects of the invention will be further elaborated in the following description of the concepts and structures of the invention with reference to the accompanying drawings.

### BRIEF DESCRIPTION OF THE DRAWING

FIG. 1 is a schematic perspective view showing an annular retainer with a barrier constructed consistent with a first embodiment of the present invention.

FIG. 2 is a schematic perspective view showing a food container comprising a cover with a barrier constructed consistent with a second embodiment of the present invention.

FIG. 3 is an exploded view showing the cover and the barrier of FIG. 2.

### DETAILED DESCRIPTION OF THE INVENTION

While this invention is illustrated and described in preferred embodiments, the barrier and the retainer for retaining the barrier may be produced in many different configurations, sizes, forms and materials, and may be retained to fit to the container in various manners.

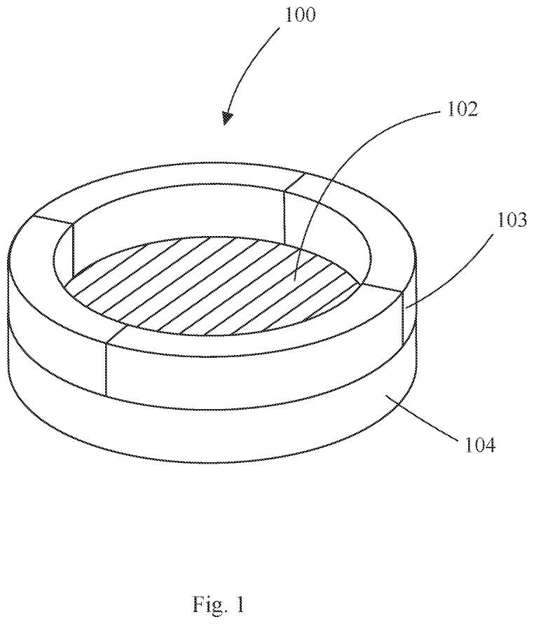

Referring now to the drawings, FIG. 1 illustrates a barrier 102 according to a first embodiment of the invention, which is retained by a retainer 100 adapted to fit to the container. The barrier is configured to be permeable to gas, e.g., air, while remaining impermeable to moisture or water. The barrier 102 is deployed to serve as a barrier to at least a part of the open top of a food container in a manner to allow air inside the container body to pass through the barrier freely, but prevent moisture or liquid water from being escaped from the container body. The barrier 102 may be made of a moisture tight and gas permeable material through which air is permeable but water is impermeable at any conditions, e.g. in the fridge, at room temperature, under microwave heating or steaming.

The moisture tight and gas permeable material may comprise a micro- or nano-porous hydrophobic plastic in the form of a flat or slightly curved plastic film or plastic sheet. The porous hydrophobic plastic comprises a microstructure and/or nanostructure formed by eliminating encapsulated micro- or nano-particles present in the injection molded plastic to provide micropores and/or nanopores. By providing the hydrophobic porous plastic, one can prevent passage of liquids, e.g., liquid water or moisture while permitting air to pass. Typically, such a plastic barrier can prevent passage of the substantial majority of moisture that comes into contact with the plastic.

Alternatively, the moisture tight and gas permeable material may comprise one or more hydrophobic nanofiber polymers, e.g. Poly(ε-caprolactone)s (PCL), Poly(lactide/glycolide) (PLGA), Poly(d,l-lactide)s (PLA), Polydimethylsiloxane (PDMS). One exemplary barrier 102 is made of woven or non-woven cloth. Another example of the barrier is a microporous polymeric material.

As illustrated in FIG. 1, the retainer 100 is an annular member comprising an upper annular ring 103 and a lower annular ring 104. In this embodiment, the upper and lower annular rings 103, 104 are of the substantially same dimension, and are tightly engageable with each other to releasably clamp the moisture-tight and gas permeable barrier 102 in a way that the barrier 102 is completely sealed and watertight circumferentially between the two annular rings 103, 104.

The retainer 100 is devised to circumferentially resemble the open top or the cross-section of the container body of a food container, and disposed hermetically in press-fit manner.

The barrier 102 can be removed from the retainer 100 for washing purpose, and then hermetically re-mounted between the upper annular ring 103 and lower annular ring 104 for reuse.

The retainer 100 with the barrier 102 is adapted to removably press fit to a cylindrical container body of the food container. For example, the lower annular ring 104 of the retainer 100 may be configured for placement over and to press fit to the circumferential edge of the open top of the container body. Alternatively, the retainer 100 may press fit onto an inner wall of the cylindrical container body to close the open top.

The food container with the barrier 102 has the capability of keeping the food items in the food container for storage and for cooking by retaining the water content and maintaining the desired atmospheric conditions through gas exchange within the food container throughout the transportation, low temperature storage, room temperature storage, microwave heating and steaming of the food within the container.

It is further contemplated that the food container may comprise a cover placed over and coupled with the upper annular ring 103 of the retainer 100. Alternatively, the cover is placed over and engaged with the open top of the food container, with the retainer 100 having the barrier 102 removably accommodated inside the container body and snugly biasing against the inner wall of the container body.

The cover can be coupled to completely seal the food container for storage when necessary by a sealing material using a method known in the art. For example, the cover may comprise an annular slot to accommodate a sealing ring which biases against the inner wall of the open top of the container body.

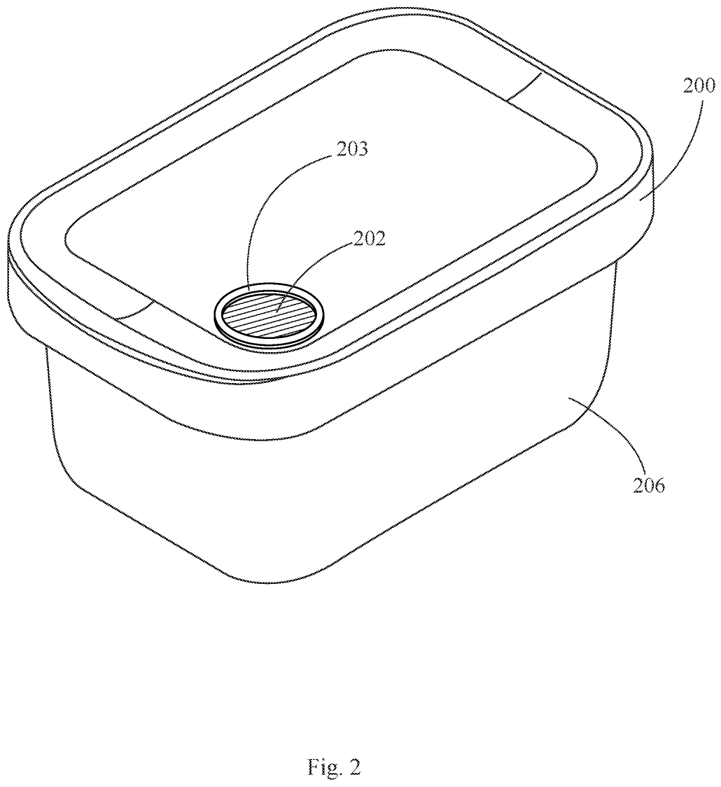

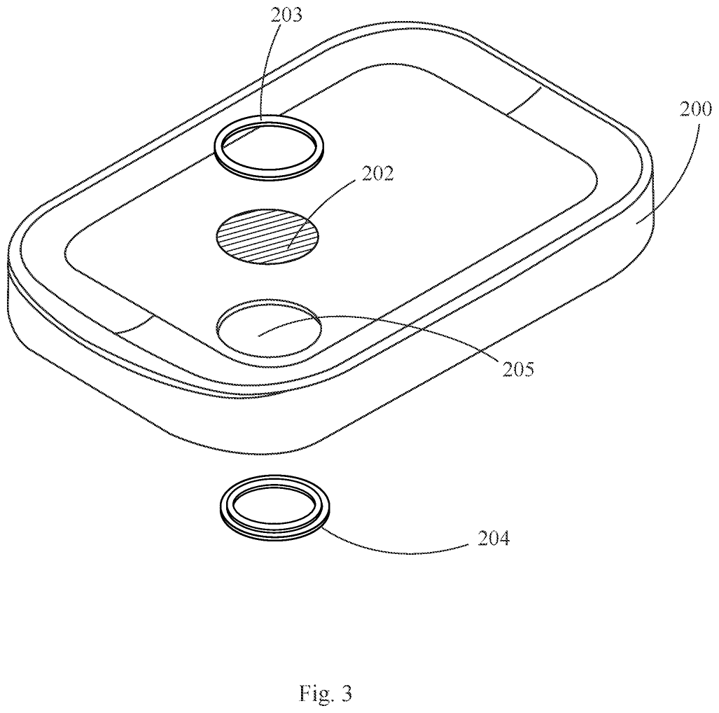

FIGS. 2 and 3 provide a food container constructed consistent with a second embodiment of the invention. In this embodiment, the food container comprises a container body of substantially rectangular cross section, a cover 200 for hermetically closing the container body so as to be openable and closable. The cover 200 has a through hole 205 with which a moisture-tight and gas permeable barrier 202 is engageable. The cover 200 is configured for hermetical placement over the open top of the container body, for example by a sealing ring using a method known in the art.

The moisture-tight and gas permeable barrier 202 has the substantially same structures and properties as the barrier 102 of the first embodiment discussed above, and may be made of the same materials of the barrier 102. The barrier 202 in this embodiment differs from the barrier 102 of the above embodiment in that this barrier 202 is configured to engage with the through hole 205 of the cover of the container.

Similarly, the moisture-tight and gas permeable barrier 202 is retained by a retainer 200 comprising an upper annular ring 203 and a lower annular ring 204 which are engageable with each other. The retainer 200 is configured so as to removably press fit into the through hole 205. The barrier 202 is hermetically and releasably mounted between the upper annular ring 203 and lower annular ring 204. Either or both of the upper annular ring 203 and the lower annular ring 204 are sized and shaped to removably press into the through hole 205. Because the cover 200 is fluidly impermeable, the air can only permeate the barrier 202 to the atmosphere through the barrier 202.

In an alternative embodiment, one of the upper annular ring 203 and the lower annular ring 204 can be formed in integration with the cover 200, and the other of the upper annular ring 203 and the lower annular ring 204 may be removable from the cover 200 so as to releasably retain the barrier 202 in between. For instance, the lower annular ring 204 is formed integrally with the cover 200 at the bottom of the through hole 205, and the upper annular ring 203 is removably engageable with the cover 200 at the top of the through hole 205, and vice versa.

The food container can further comprise a locking mechanism to locking the cover over the top of the container body, which would be within the ability of a person skilled in the art.

The above described are preferred embodiments of the barrier adapted for the food container for keeping the food items fresh and for cooking. It is understood that the present invention is not limited to the above embodiments and any appropriate modifications can be adopted within the scope of the present invention as long as they can achieve the effects of the present invention.

1. A food container comprising
a container body having an open top, and
a moisture-tight and gas permeable barrier removably deployed to serve as a barrier to at least a part of the open top of the container in a manner to allow gas inside the container body to pass therethrough while to prevent moisture from being escaped from the container body.

2. The food container according to claim 1, wherein the barrier is adapted to removably fit onto an inner wall surface of the container body or over the open top of the container body to fully cover a cross-section of the container body.

3. The food container according to claim 1, further comprising a retainer for releasably retaining the barrier, the retainer being adapted to removably press fit to the container body.

4. The food container according to claim 3, wherein the retainer comprises
an upper perimetric ring, and
a lower perimetric ring engageable with the upper perimetric ring,
wherein the barrier is hermetically and releasably mounted between the upper perimetric ring and lower perimetric ring.

5. The food container according to claim 1, further comprising a cover for hermetically closing the container body so as to be openable and closable, wherein the cover comprises a through hole with which the barrier is engageable tightly.

6. The food container according to claim 5, further comprising a retainer for releasably retaining the barrier, the retainer being adapted to removably press fit to the container body, or press fit into or be integral with the through hole of the cover.

7. The food container according to claim 6, wherein the retainer comprises
an upper perimetric ring, and
a lower perimetric ring engageable with the upper perimetric ring,
wherein the barrier is hermetically and releasably mounted between the upper perimetric ring and lower perimetric ring.

8. The food container according to claim 7, wherein one of the upper perimetric ring and the lower perimetric ring is integral with the through hole of the cover, and the other is removably engageable with said perimetric ring integral with the cover.

9. The food container according to claim 3, wherein the retainer is annular, rectangular, or ovoid in shape.

10. The food container according to claim 1, wherein the barrier is formed as a piece of porous plastic configured to be permeable to gas while remaining impermeable to moisture or liquid.

11. The food container according to claim 10, wherein the porous plastic comprises a microstructure and/or nanostructure formed by eliminating encapsulated micro- or nano-particles present in the plastic.

12. The food container according to claim 1, wherein the barrier is provided in the form of a membrane comprising one or more hydrophobic nanofiber polymers selected from a group consisting of Poly(ε-caprolactone), Poly(lactide/glycolide), Poly(d,l-lactide), and Polydimethylsiloxane.

13. The food container according to claim 1, wherein the barrier is provided in the form of a woven or non-woven cloth, or a porous polymeric material membrane.

14. The food container according to claim 2, further comprising a retainer for releasably retaining the barrier, the retainer being adapted to removably press fit to the container body.

15. The food container according to claim 14, wherein the retainer comprises
an upper perimetric ring, and
a lower perimetric ring engageable with the upper perimetric ring,
wherein the barrier is hermetically and releasably mounted between the upper perimetric ring and lower perimetric ring.

16. The food container according to claim 2, further comprising a cover for hermetically closing the container body so as to be openable and closable, wherein the cover comprises a through hole with which the barrier is engageable tightly.

17. The food container according to claim 16, further comprising a retainer for releasably retaining the barrier, the retainer being adapted to removably press fit to the container body, or press fit into or be integral with the through hole of the cover.

18. The food container according to claim 6, wherein the retainer is annular, rectangular, or ovoid in shape.

19. The food container according to claim 7, wherein the retainer is annular, rectangular, or ovoid in shape.
